(19) United States
(12) Patent Application Publication
(10) Pub. No.: US 2004/0177203 A1
(43) Pub. Date: Sep. 9, 2004

(54) Dual time sliced circular bus

(75) Inventors: Kenneth J. Goodnow, Essex, VT (US); Riyon Harding, Richmond, VT (US); Frances A. Kampf, Jeffersonville, VT (US); Thomas M. Lepsic, Jeffersonville, VT (US)

Correspondence Address: IBM MICROELECTRONICS, INTELLECTUAL PROPERTY LAW, 1000 RIVER STREET, 972 E, ESSEX JUNCTION, VT, 05452, US

(73) Assignee: International Business Machines Corporation, Armonk, NY

(21) Appl. No.: 10/248,527

(22) Filed: Jan. 27, 2003

(51) Int. Cl. G06F 13/14

(52) U.S. Cl. 710/305

(57) ABSTRACT

A dual time sliced circular bus extending in opposite directions, and optionally interspersed so as to reduce noise. The width of the buses can either be dynamic or static depending upon the particular implementation. Circulating on each of the buses is a predetermined number of data structures for either transmitting an address operation or data. Each of the cores can use the data structures for transmitting and receiving data between themselves according to a transmitting and receiving scheme.

### BACKGROUND OF INVENTION

1. Field of the Present Invention

The present invention generally relates to a system for providing communications between cores in an integrated circuit and, more particularly, to systems using a dual time sliced circular bus.

2. Description of Related Art

A typical processing device includes various circuits such as a processor circuit, memory circuits, peripheral circuits, and the like. With recent technology, such a device may be manufactured using a printed circuit board supporting a plurality of integrated circuit chips. Each integrated circuit chip provided the functionality of one or more of the circuits. The individual circuits can be thought of as core circuits, or cores. When connected on a printed circuit board, the core circuits are often connected with point to point wiring.

The semiconductor industry has recently advanced to System-On-a-Chip (SOC) technology. This technology is used, for example, in large Application Specific Integrated Circuits (ASICs) with many cores. With the advancement of this technology and the increased number of cores being placed on a SOC, the interconnection between the cores has become problematic due to wiring constraints and wiring congestion.

Various techniques have been implemented for compensating for this congestion, such as bus type structures. Unfortunately, these bus structures typically include an arbiter, and therefore, unable to handle more than a single transaction on the bus for any given moment in time. Consequently, these types of buses have limited uses within an integrated circuit (e.g. where speed is not crucial)It would, therefore, be a distinct advantage to have a bus structure that could be used within an integrated circuit to provide communication between the various cores. It would be further advantageous, if the bus structure could support multiple transactions at the same time. The present invention provides such a bus structure.

### SUMMARY OF INVENTION

In general, the present invention provides a dual time sliced circular bus extending in opposite directions, and optionally interspersed so as to reduce noise. The width of the buses can either be dynamic or static depending upon the particular implementation. Circulating on each of the buses is a predetermined number of data structures for either transmitting an address operation or data. Each of the cores can use the data structures for transmitting and receiving data between themselves according to a transmitting and receiving scheme.

### BRIEF DESCRIPTION OF DRAWINGS

The foregoing and other aspects and advantages will be better understood from the following detailed description of a preferred embodiment of the invention with reference to the drawings, in which:

### DETAILED DESCRIPTION

The present invention is a dual time sliced circular bus structure having first and second buses providing communication in clockwise and counterclockwise directions, respectively. The first and second buses travel thru multiple cores each of which are capable of transmitting or receiving data using recirculating data structures that reside on each one of the buses. The data structures they are always present on the bus and in a continuous rotation pattern. The particular format for the data structures can be either static or dynamic depending upon the particular design being implemented. Data is transmitted and received using these data structures according to predetermined data scheme as explained in more detail below.

Bus Structure

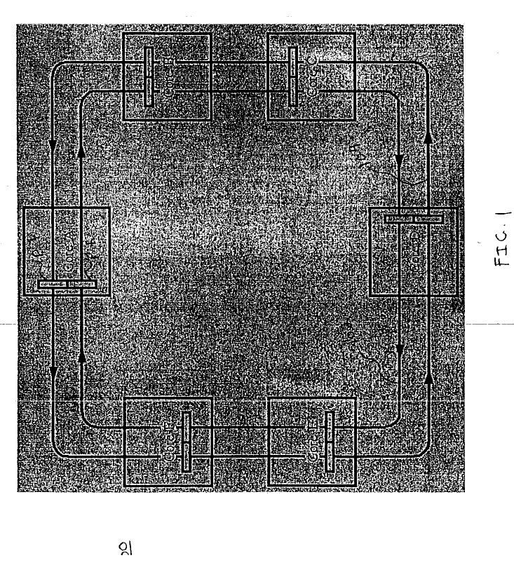

Reference now being made to FIG. 1, a schematic diagram is shown illustrating a preferred embodiment for implementing a dual time sliced circular bus structure 102-104 in an integrated circuit 100 according to the teachings of the present invention. The circular bus structure includes a first bus 102 for transmitting in a clockwise direction, and a second bus 104 for transmitting in a counter-clockwise direction. Providing communication in both circular directions has many advantages, the most obvious being more efficient communication between the cores A-F.

Located within each of the buses is cores A-F each of which has a receiving circuitry (receiving circuitry) for receiving and transmitting data thereon. Each one of the cores A-F can reserve a predetermined number of the static number of data structures using a reservation counter (not shown).

The first and second buses 102-104 can be interspersed so that an individual wire would be bound on both sides by wires from the opposite direction bus. This type of arrangement would restrict electrical interference to occurring only as the waves were next to each other, and that ideally would only occur for a short span of time during each bus transaction.

The clocking for the buses 102-104 can be accomplished in numerous ways. For example, a maximum fixed length path scheme can be used. In this approach, the cores A-F act as stations along the bus 102 or 104, and should be placed less than one clock period from the previous core A-F. The placement within the range of the single clock period guarantees that the bus transaction can occur at a proscribed frequency.

If the cores A-F need to violate the distance requirement, then either the bus speed can be decreased, or a repeater (not shown) added to the bus. In general, the repeater would contain the circuitry necessary to receive and retransmit signals from/to the next core A-F.

Another embodiment for the clocking for the buses 102-104, is to have the clock generated at one of the cores A-F, and then propagated along with the data structure to the next core A-F.

Data Structure

The data structures used for transmitting and receiving data on the buses 102-104 are either of an address operation or data transmission type. The width of the data structures can either be fixed or dynamic. In the preferred embodiment of the present invention, the data structures are of a fixed nature. The data structure for transmitting an address operation is illustrated as:

| | | | | | | |
|---|---|---|---|---|---|---|
| Occupied | Reserved | Tag | Ack/Retry | Opcode | State | Address |

The occupied field indicates whether the data structure is currently being used. The reserved field indicates whether the data structure is reserved for an operation by a core A-F, the Tag field identifies the core making the address operation request, the Ack/Retry field is used for indicating whether the destination core A-F acknowledged receiving the address request or requested a retry, the opcode field is used for helping determine the type of operation and any special operations and/or functions, the state field is used for indicating whether the information contained in the data structure is valid, and the address field is used for indicating the address information for the address operation.

The data structure for transmitting data is as follows:

| | | | | |
|---|---|---|---|---|
| Occupied | Reserved | Tag | Ack/Retry | Data |

The occupied field indicates whether the data structure is currently being used, The reserved field indicates whether the data structure is reserved for an operation by a core A-F, the Tag field indicates the address information for the address operation, the Ack/Retry field is used for indicating whether the data has been acknowledged or a retry is requested. The data field contains the data for the identified address information.

In a dynamic or variable length data structure, the above data structures would also include a size field indicating how many wires it uses across the bus 102 or 104.

As each data structure travels the bus, it stops (i.e. the cores A-F read/modify the information contained in the data structure prior to releasing the data structure).

Assume for the moment that there are six data structures numbered 1 to 2 respectively. Also, assume that core A desires to transfer data to core C. In this particular instance, it can also be assumed that data structures 1 to 2 have not yet been used and data structure 1 has just been received by Core A.

Address Operation Scheme

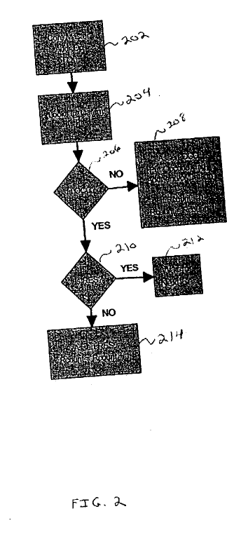

Reference now being made to FIG. 2, a flow chart is illustrated showing the method used by a core master for initiating an address operation according to the teachings of the present invention. Continuing with the example started above, the Core master in this instance is Core A, and data structure 1 has just been received in its pit. It can also be assumed that the data structure for the car is fixed as enumerated above.

Core A examines the occupied field of data structure 1 (step 204) to determine if the data structure is being used. If the occupied field is not set, then core sets the occupied field, tag, address, state, and/or data in the data structure, and if the reserved count is greater than zero, it decrements the reserved count. Thereafter, the data structure 1 is released for dissemination to the next core.(step 208).

If data structure 1 is occupied, then core A examines the reserved field to determine if data structure 1 has been reserved (step 210). If data structure 1 has been reserved, then core A releases data structure 1 for further dissemination to the next core (step 212). If data structure 1 is not reserved, then core A sets the reservation field, increments its reserved counter, and releases the data structure 1 for further dissemination to the next core (step 214).

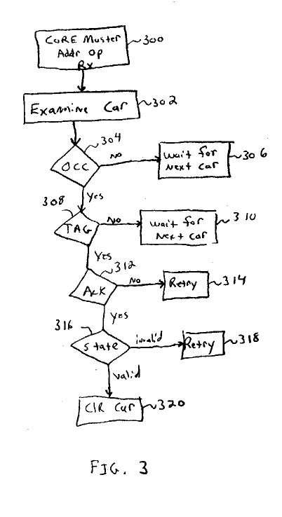

Reference now being made to FIG. 3, a flow chart is shown illustrating the method used by cores A-F for receiving an address operation request response in accordance with the teachings of the present invention. Continuing with the above example, and assuming that data structure 1 has completed its trip around the bus to the other cores B-F. Core A receives data structure 1 in its pit and examines the contents (steps 300-302). Core A examines the occupied field to determine if data structure 1 is being used (step 304). If the occupied field is not set, then core A releases the data structure and allows its dissemination to the next core.

If, however, the occupied field is set, then core A examines the Tag field (step 308). If the tag field does not indicate that core A was the originator of the address operation, then core A releases data structure 1 for further dissemination to the next core (step 310).

If the tag field does identify core A as the originator of the address operation, then core A examines the Ack/Retry field (step 312). If the Ack/Retry field indicates that the request should be retried, then core A clears the Ack/Retry field, and releases data structure 1 for further dissemination to the next core (step 314).

Core A then examines the state field (step 316). If the state field indicates that the information contained in data structure 1 is invalid, then core A clears the state field and releases data structure 1 for further dissemination to the next core (step 318). If the state field indicates that the information is valid, then core A clears the fields, other than the reserved field, and releases data structure 1 for further dissemination to the next core.

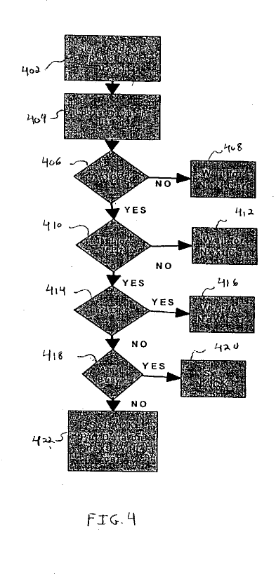

Reference now being made to FIG. 4, a flow chart is shown illustrating the method used by the slave cores A-F which receive address operations on the buses 102-104 for a read operation according to the teachings of the present invention. Continuing with the example of core A being the master which has just placed address information into data structure 1, and further assuming that data structure 1 is traveling on bus 104, and the address operation is for reading data. Core F receives data structure 1 and examines the occupied field to determine if the data structure is data information (steps 402-406). If the occupied field of data structure 1 is not set, then core F releases data structure 1 for further dissemination to core E (steps 406-408).

If, however, the occupied field of data structure 1 is set, then core F determines whether the address is for itself by examining the opcode and address field (step 410). If the address does not match that for core F, then core F releases data structure 1 for further dissemination to core E (step 412). If the address does match that for core F, then core F examines the acknowledge field (step 414). If the acknowledge field is set, then this indicates that another core has updated data and will supply the data to core A, and core F releases data structure 1 for further dissemination to core E (step 416).

If the acknowledge field is not set, then core F determines whether it can acknowledge the request for data (step 418). If core F can acknowledge the data, then core F sets the acknowledge field, and releases data structure 1 for further dissemination to the next core (core E in this example) (step 422). If core F is unable to acknowledge the data, then core F sets the non-acknowledge field and releases data structure 1 for further dissemination to the next core (step 420).

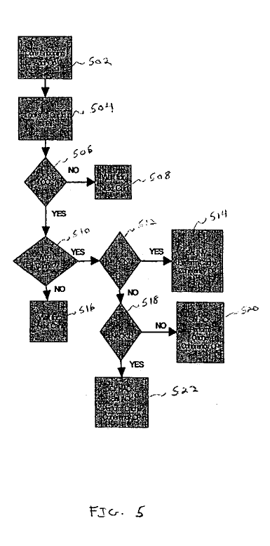

Reference now being made to FIG. 5, a flow chart is shown illustrating the method used by cores A-F for snooping an address operation according to the teachings of the present invention. Core snooping begins when a core A-F receives a data structure in its pit (step 504). The core examines the received data structure to determine if the occupied field has been set (step 506). If the occupied field is not set, then the core releases the data structure for further dissemination to the next core (step 508).

If the occupied field is set, then the core determines whether the data resides in its cache and whether the data is modified (step 510). If it is determined that either the data does not reside in the cache or the data resides, but is not modified, then the core releases the data structure for dissemination to the next core (step 516).

If the data resides in the cache of the core and the data has been modified, then the core examines the ack/retry field (step 512). If the ack/retry field indicates that the address request has been acknowledged by another core, then the present core sets the state field to invalid and performs a cache coherency operation (step 514). A cache coherency operation as used herein means that the data is sent back on the bus with an update cache opcode.

If the ack/retry field does not indicate that the data request should be retired, then the present core sets the ack/retry field to indicate that the address operation has been acknowledged, and performs a cache coherency operation (step 520).

If the ack/retry field indicates that the data request should be retried, then the present core clears the ack/retry field, and performs a cache coherency operation (step 522).

Data Operation

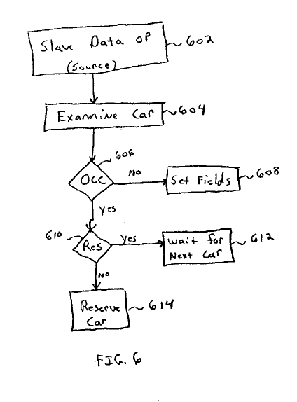

Reference now being made to FIG. 6, a flow chart is shown illustrating the method used by the cores A-F for sourcing data in response to acknowledging a prior address operation according to the teachings of the present invention. The core A-F sourcing the data (in this example Core A) receives a data structure (in this example it can be assumed it is data structure 2), and examines the contents of the data structure (step 602-604). The receiving core examines the occupied field of data structure 2 to determine if it is occupied. If the occupied field of data structure 2 indicates that it is not occupied, then the core sets occupied field, the Tag field, and data field (step 608).

If the occupied field of data structure 2 indicates that it is occupied, then the core examines the reserved field (step 610). If the reserved field is set, then the core releases data structure 2 for further dissemination to the next core (step 612). If, however, the reserve field is not set and the maximum value for the reserve count is not exceeded, then the core sets the reserved field, increases its reserve counter, and releases data structure 2 for further dissemination to the next core.

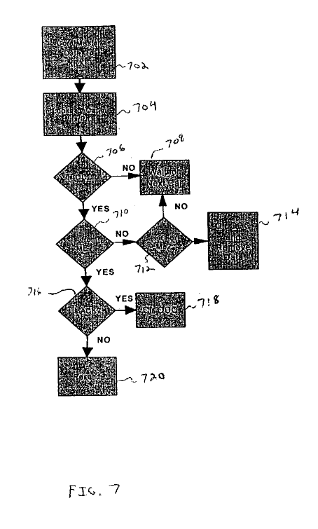

Reference now being made to FIG. 7, a flow chart is shown illustrating the method used by the source core A-F for re-transmitting data according to the teachings of the present invention. Continuing with the example of data structure 2, further assume that data structure 2 has made it completely around the bus to be received once again by core A and examined (step 702). Core A examines the occupied field to determine whether data structure 2 is occupied with data (step 704). If the occupied field indicates that data structure 2 is not occupied, then core A releases data structure 2 for further dissemination to the next core (step 708).

If the occupied field indicates that data structure 2 is occupied, then core A examines the Tag field to determine whether the data was sent by core A (step 710). If the tag field indicates that the data was not sent by core A, then core A proceeds to determine whether the data is for core A (step 712). If the data is for core A, then core A removes the data, clears the occupied field, and releases data structure 2 for further dissemination to the next core (step 714).

If the tag field indicates the data was sent by core A, then core A examines the ack/retry field (step 716). If the ack/retry field indicates an acknowledgment that the data sent was received, then core A clears the occupied field, and releases data structure 2 for further dissemination to the next core (step 718). If, however, the ack/retry field indicates a retry, then core A, releases the core for further dissemination to the next core (step 720).

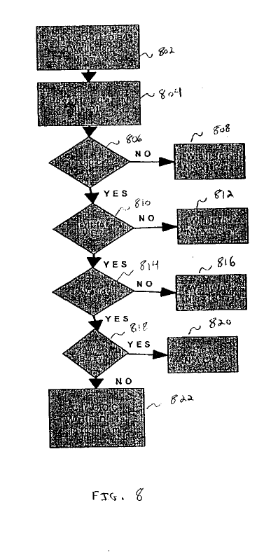

Reference now being made to FIG. 8, a flow chart is shown illustrating a method used by cores A-F when receiving a data operation for writing to memory according to the teachings of the present invention. Continuing the example with data structure 2, assume that core A has initiated a write memory address and data via data structure 2, and the request is now being received by core F. Core F receives data structure 2 and examines the occupied field (steps 802-806).

If data structure 2 is unoccupied, then core F releases data structure 2 for further dissemination to the next core on the bus (steps 806-808). If the occupied field of data structure 2 is set, then core F determines whether the address field matches its address (step 810). If the address field does not match the address of core F, then data structure 2 is released for further dissemination to the next core (step 812).

If the address field does match the address of core F, then core F examines the state field to determine whether the data is valid (i.e. another core could have indicated that it has the correct/updated data for cache coherency) (step 814). If the state field indicates that the data is valid, then core F determines whether it can write to memory at this time (step 818). If core F is unable to write to memory at this time, the ack/retry field is set to retry, and data structure 2 is released for further dissemination to the next core (step 820).

If core F is able to write to memory at this time, then core F clears the occupied field of data structure 2, writes the data contained in data structure 2 to memory, and releases data structure 2 for further dissemination to the next core (step 822).

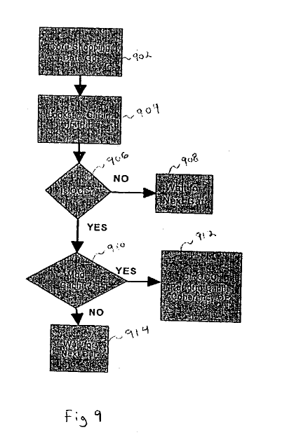

Reference now being to FIG. 9, a flow chart is shown illustrating a method used by cores A-F for snooping data sourcing according to the teachings of the present invention. Continuing with the example involving data structure 2, assume that Core F is the destination and that Core E has updated data residing in its cache. Core E receives Data structure 2 as it is released from core F and examines the occupied field (steps 902-906). If the occupied field is not set, then core E releases data structure 2 for further dissemination to the next core (step 908).

If the occupied field is set, then core E determines whether it has the same data modified in its cache (step 910). If core E has the same data modified in its cache, then core E clears the occupied field, performs a cache coherency operation, and releases data structure 2 for further dissemination to the next core (step 912). If core E does not have the same data modified in its cache, then core E releases data structure 2 for further dissemination to the next core (step 914).

1. An integrated circuit comprising:
a first bus for transmitting data;
a plurality of first data structures each of which is continuous transmitted on the first bus; and
a plurality of cores each of which is coupled to the first bus to receive each one of the first data structures, and to transmit data in the first data structures.

2. The integrated circuit 1 further comprising:
a second bus for transmitting data; and
a plurality of second data structures each of which is continuously transmitted on the second bus.

3. The integrated circuit of claim 2 wherein each one of the cores is coupled to the second bus to receive each one of the second data structures, and to transmit data in the second data structures.

4. The integrated circuit of claim 3 wherein the first bus is circular, and the first data structures are transmitted on the first bus in a clockwise direction.

5. The integrated circuit of claim 4 wherein the second bus is circular, and second data structures are transmitted and received on the second bus in a counter-clockwise direction.

6. The integrated circuit of claim 5 wherein each one of the first and second data structures includes an occupied field to indicate whether the data structure is currently being used.

7. The integrated circuit of claim 6 wherein each one of the first and second data structures includes a reservation field to indicate whether the data structure has been reserved for an operation once it has completed its current task.

8. The integrated circuit of claim 6 wherein each one of the cores examines the occupied field of the first and second data structures to determine whether the data structures contain data.

9. A bus structure comprising:
a first bus to transmit data;
a plurality of cores each coupled to the first bus; and
a plurality of first data structures to transmit data, each one of the data structures being continuously circulated on the first bus.

10. The integrated circuit of claim 9 wherein each one of the cores receives each one of the data structures as they circulate on the first bus.

11. The integrated circuit of claim 10 wherein the first bus is circulating the first data structures in a clockwise direction.

12. The integrated circuit of claim 11 wherein each one of the first data structures includes an occupied field to indicate whether the data structure is currently being used.

13. The integrated circuit of claim 11 further comprising:
a second bus to transmit data; and
a plurality of second data structures to transmit data, each one of the second data structures being continuously circulated on the second bus.

14. The integrated circuit of claim 13 wherein each one of the cores receives each one of the second data structures as the second data structure is circulated on the second bus.

15. The integrated circuit of claim 14 wherein each one of the first and second data structures includes a reservation field to reserve the data structure for another operation once its current task is completed.

16. The integrated circuit of claim 15 wherein each one of the cores includes a reservation counter for indicating the number of first or second data structures that have been reserved.

17. The integrated circuit of claim 15 wherein a first one of the plurality of cores receives a first one of the plurality of first data structures, the received first data structure indicating that its is occupied via the occupied field, the first one of the plurality of cores setting the reservation field of the received first data structure to indicate that its is reserved after it completes its current task, and incrementing its reservation counter.

18. The integrated circuit of claim 15 wherein the first one of the plurality of cores receives a second one of the plurality of first data structures, the received data structure indicating that it is not occupied via its occupied field, and indicating that it was reserved via its reservation field, the first one of the plurality of cores decrementing its reservation counter, and clearing the reservation field of the received second first data structure.

19. The integrated circuit of claim 14 wherein the first bus is circulating the first data structures in a clockwise direction, and the second bus is circulating the second data structures in a counter-clockwise direction.

20. The integrated circuit of claim 18 wherein each one of the cores is organized in a circular pattern with respect to the first and second buses.

21. The integrated circuit of claim 19 wherein each one of the cores is one clock cycle from one another.
